(19) United States
(12) Patent Application Publication
(10) Pub. No.: US 2022/0116819 A1
(43) Pub. Date: Apr. 14, 2022

(54) METHOD AND APPARATUS FOR REPORTING RLC LAYER STATUS, STORAGE MEDIUM AND USER EQUIPMENT

(71) Applicant: SPREADTRUM COMMUNICATIONS (SHANGHAI) CO., LTD., Shanghai (CN)

(72) Inventor: Yun DENG, Shanghai (CN)

(21) Appl. No.: 17/555,869

(22) Filed: Dec. 20, 2021

Related U.S. Application Data
(63) Continuation of application No. 15/855,359, filed on Dec. 27, 2017.

(30) Foreign Application Priority Data
May 5, 2017 (CN) 201710311267.6

(51) Int. Cl. H04W 28/04; H04L 1/16; H04L 1/18

(52) U.S. Cl. CPC H04W 28/04; H04L 1/1854; H04L 1/1621

(57) ABSTRACT

Method and apparatus for reporting an RLC layer status, storage medium and user equipment are provided. The method includes: determining whether an RLC status report needs to be transmitted in an acknowledgment mode; based on that the RLC status report needs to be transmitted, determining at least one unacknowledged sequence number length, wherein the unacknowledged sequence number length is selected from a set of unacknowledged sequence number length including elements pre-defined by a transmitter and a receiver; generating the RLC status report based on the at least one unacknowledged sequence number length and a sequence number of a start RLC data packet of RLC data packets consecutively unreceived, wherein the RLC status report is in a preset format of RLC status report, and records the total number of the RLC data packets consecutively unreceived and the sequence number of the start RLC data packet; and transmitting the RLC status report.

### CROSS-REFERENCE TO RELATED APPLICATIONS

This application is a Continuation application of the U.S. patent application Ser. No. 15/855,359, which claims the benefit of priority to Chinese Patent Application No. CN201710311267.6, filed on May 5, 2017, the entire disclosure of which is incorporated herein by reference.

### TECHNICAL FIELD

The present disclosure generally relates to communication technology field, and more particularly, to a method and apparatus for reporting an RLC layer status, a storage medium and user equipment.

### BACKGROUND

In a mobile communication system, a Radio link control (RLC) protocol is a part of a layer 2 protocol, and has a segmentation and an Automatic Repeat-reQuest (ARQ) function. The RLC uses two mechanisms of acknowledgment and timeout, to realize a reliable information transmission on a basis of an unreliable link.

In order to ensure a reliable transmission, a receiver transmits an RLC layer status report (i.e., RLC status report) to a transmitter to report the RLC layer status. For example, information such as a sequence number of a data packet unreceived may be indicated in the RLC status report. The transmitter may retransmit the corresponding data packet to the receiver after receiving the RLC status report. In a Long Term Evolution (LTE) system, the RLC status report may include one or more sequence numbers (NACK SN) of the RLC layer data packets that have not been received or acknowledged.

In a New Radio (NR) represented by 5G, unlike the RLC layer in the LTE, the RLC layer in the NR does not have a concatenation function. Therefore, in a New Radio, for a data radio bearer, multiple RLC data packets may be transmitted within a Transmission Time Interval (TTI). Once a data packet transmitted during the transmission time interval is lost or cannot be accurately decoded, multiple RLC data packets belonging to the same TTI need to be set as unacknowledged packets. Accordingly, continuing applying the current method for transmitting an RLC layer status report to report the RLC layer status can result in information redundancy, and low transmission efficiency.

Therefore, the 3rd Generation Partnership Project (3GPP) decides to introduce an unacknowledged sequence number length (NACK SN Range) in the RLC status report in order to reduce the number of bits of the RLC status report and avoid a too great number of bits of the RLC status report (for example, sequence numbers of unacknowledged data packets need to be sequentially indicated in an RLC status report in the existing techniques).

However, details about how to set the length of the unacknowledged sequence number in the RLC status report are not specifically ruled in the existing protocol. And if all the unacknowledged sequences have a uniform length, a serious waste of bits may still occur in practical applications.

### SUMMARY

Embodiments of the present disclosure aim to provide a method for reporting an RLC layer status. The RLC layer status report may be transmitted with fewer bits, so as to improve transmission efficiency.

In one embodiment, a method for reporting an Radio Link Control (RLC) layer status is provided, including: determining whether an RLC status report needs to be transmitted, based on being in an acknowledgment mode; based on that the RLC status report needs to be transmitted, determining at least one unacknowledged sequence number length, wherein the unacknowledged sequence number length is selected from a set of unacknowledged sequence number length; generating the RLC status report based on the at least one unacknowledged sequence number length, wherein the RLC status report is in a preset format of RLC status report; and transmitting the RLC status report.

In one embodiment, an apparatus for reporting an Radio Link Control (RLC) layer status is provided, including: a determining circuitry, configured to determine whether an RLC status report needs to be transmitted, based on being in an acknowledgment mode; a confirming circuitry, configured to: based on that the RLC status report needs to be transmitted, determine at least one unacknowledged sequence number length, wherein the unacknowledged sequence number length is selected from a set of unacknowledged sequence number length; a generating circuitry, configured to: generate the RLC status report based on the at least one unacknowledged sequence number length, wherein the RLC status report is in a preset format of RLC status report; and a transmitting circuitry, configured to: transmit the RLC status report.

In one embodiment, a storage medium which has computer instructions stored therein is provided, wherein once the computer instructions are executed, the method according to any one of methods is performed.

In one embodiment, a user equipment including a memory and a processor is provided, wherein the memory has computer instructions stored therein, and once executing the computer instructions, the processor performs the method according to any one of method.

### BRIEF DESCRIPTION OF THE DRAWINGS

FIG. 1 schematically illustrates a flow chart of a method for reporting an RLC layer status according to a first embodiment of this disclosure;

FIG. 2 schematically illustrates a principle diagram of a typical application scene according to the first embodiment of this disclosure;

FIG. 3 schematically illustrates a structural diagram of a format of the RLC status report according to the first embodiment of this disclosure; and

FIG. 4 schematically illustrates a structural diagram of an apparatus for reporting an RLC layer status according to a second embodiment of this disclosure.

### DETAILED DESCRIPTION

Those skilled in the art can understand that, as described in the background, although the 3rd Generation Partnership Project (3GPP) decides to introduce an unacknowledged sequence number length (NACK SN Range) in the RLC status report in order to reduce the number of bits of the RLC status report, a problem that bits are comparably seriously wasted in the current RLC status reports still exists, and transmission efficiency is influenced.

Inventors of the present disclosure found after analysis that the above problem exists because the existing protocol does not specifically rule details about how to set the length of the unacknowledged sequence number in the RLC status report.

For example, a user equipment (User Equipment, referred to as UE) in the 5G may perform a plurality of different types of services, and data transmission rates of various services vary widely. A low-rate service may require to transmit 10 k bits in a transmission time interval (Transmission Time Interval, referred to as TTI), and usually a packet does not exceed 1500 bytes, that is 12000 bits, therefore this service usually transmits one or several RLC data packets in a transmission time interval. A medium-rate service can require transmitting 1 M bits in a time interval, and this service usually transmits about 100 RLC data packets in a transmission time interval. The high-rate service also may require transmitting 20 M bits or more in one transmission time interval, and this service usually transmits about 2000 RLC data packets in a transmission time interval. Based on the existing technology, one transmission time interval in 5G may be a duration of one subframe or one slot, or only the duration of a partial slot. For a downlink (that is, the base station transmits data to the user equipment), if the user equipment fails to analyze the data within one transmission time interval, it means that all the RLC data packets in the transmission time interval are all unreceived.

For the downlink, in practical applications, the user equipment may not correctly analyze the downlink data sent by the base station in multiple consecutive transmission time intervals, or may not correctly analyze the downlink data sent by the base station intermittently. When a base station (which may also be a network) which serves as a transmitter requests a user equipment which serves as a receiver to transmit an RLC status report, the user equipment needs to indicate the number of RLC data packets consecutively unreceived in the RLC status report. And then for the above user equipment in the 5G network, to different services, the number of RLC data packets consecutively unreceived by the user equipment may be 10 (corresponding to the low-rate service), 1000 (corresponding to the medium-rate service) or 20000 (corresponding to the high-rate service).

If the RLC status report is simply generated using uniform unacknowledged sequence number length, the unacknowledged sequence number length must be great enough to ensure that the maximum number of RLC data packets consecutively unreceived can be indicated. For example, for the user equipment in the 5G network, the length of the unacknowledged sequence number cannot be less than 15, to satisfy the condition that the number of RLC data packets consecutively unreceived is 20000. However, if the number of RLC data packets consecutively unreceived is actually only 10 when it is necessary to transmit the RLC status report, it is in fact enough as long as the length of the unacknowledged sequence number may be six. However, the current user equipment can only use 15 as the unacknowledged sequence number length, which results in a serious waste of bits and influences the transmission efficiency.

In order to solve this technical problem, in embodiments of the present disclosure, whether an RLC status report needs to be transmitted is determined when in an acknowledgment mode; if it is determined that an RLC status report needs to be transmitted, at least one unacknowledged sequence number length is determined, wherein the at least one unacknowledged sequence number length is selected from a set of unacknowledged sequence number length; the RLC status report is generated based on the unacknowledged sequence number length, wherein the RLC status report is in a preset format of RLC status report; and the RLC status report is transmitted.

Those skilled in the art can understand that, embodiments of the present disclosure allow the RLC status report generated and transmitted includes at least one unacknowledged sequence number length, so that the unacknowledged sequence number length included in the RLC status report can be flexibly adjusted according to an actual receiving situation of the receiver, and therefore the RLC status report sent by the receiver may occupy fewer bits and transmission efficiency is improved.

Further, when the receiver determines that the number of RLC data packets consecutively unreceived is greater than or equal to the preset threshold, it determines that the RLC status report needs to be transmitted. Compared with an existing technical solution that the receiver transmits the RLC status report only based on a request from a transmitter, embodiments of the present disclosure allow the receiver to actively trigger the RLC status report according to the number of the RLC data packets currently consecutively unreceived, which therefore may better improve the quality of data transmission with the transmitter.

Further, the set of unacknowledged sequence number length is received from a transmitter. For example, by comprehensively considering factors such as the number of data radio bearers, the transmission rate of every data radio bearer (can also be referred to be a bearer), a channel condition and the like of the receiver in the current transmission time interval, the transmitter may configure a set of unacknowledged sequence number length applicable to the current transmission time interval for the receiver, and then transmits to the receiver. When the determination result indicates that the RLC status report needs to be sent, the receiver selects an applicable unacknowledged sequence number length from the received set of unacknowledged sequence number length to generate the RLC status report.

Further, the element in the set of unacknowledged sequence number length is pre-defined by a transmitter and a receiver. For example, the set of unacknowledged sequence number length may include all available unacknowledged sequence number lengths applicable for the receiver. When determining that the RLC status report needs to be sent, the applicable at least one unacknowledged sequence number length is selected from the set of unacknowledged sequence number length to generate the RLC status report by the receiver. Preferably, a protocol preset set of unacknowledged sequence number length may further be pre-defined.

To make the above objects, features and beneficial effects of the present disclosure clearer and easier to understand, the specific embodiments of the present disclosure are described in detail below with reference to the accompanying drawings.

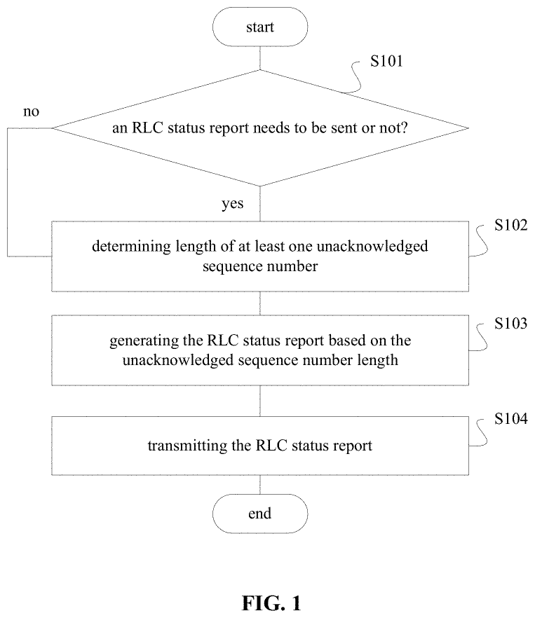

FIG. 1 schematically illustrates a flow diagram of a method for reporting an RLC layer status according to a first embodiment of the present disclosure. The RLC layer is an abbreviation of an Radio Link Control (RLC) layer; the receiver reports a current status of the RLC layer to the transmitter by transmitting an RLC layer status report; and the base station (or the network) and the user equipment may be the receiver and the transmitter, or vice verse. In this embodiment, downlink transmission is taken as an example, that is, the base station is a transmitter and the user equipment is a receiver. Those skilled in the art may also change and obtain more embodiments according to actual requirements, and details are not described herein. The transmitter and the receiver may be two terminations of a data transmission, and the transmitter (i.e., base station) transmits data to a receiver (i.e., a user equipment) via a downlink data transmission method.

Specifically, in this embodiment, step S101 is performed first, determining whether an RLC status report needs to be transmitted, based on being in an acknowledgment mode.

Further, based on the determination result in the step S101 indicating that an RLC status report needs to be transmitted, in S102, at least one unacknowledged sequence number length is determined, wherein the unacknowledged sequence number length is selected from a set of unacknowledged sequence number length.

In S103, the RLC status report is generated based on the unacknowledged sequence number length, wherein the RLC status report is in a preset RLC status report format.

In S104, the RLC status report is transmitted to report the RLC status.

As a variation, if the determination result of the step S101 indicates that the RLC status report does not need to be transmitted, the step S101 is repeatedly performed until the determination result of the step S101 is positive, and then the step S102 is performed. Preferably, the step of repeatedly performing the step S101 may be performed according to a preset period, or may be performed based on a preset event, wherein the preset period and the preset event may be determined by the receiver and/or the transmitter, or also may be pre-defined by the receiver and the transmitter.

Further, the acknowledgment mode may be a reliable data transmission mode adopted by the existing techniques. For example, the receiver in the acknowledged mode may transmit an RLC status report to the transmitter, therefore the transmitter can determine whether the data is successfully transmitted to the receiver.

As a specific embodiment, the step S101 may include: determining whether receiving request information for acquiring the RLC status report, or determining whether a number of RLC data packet consecutively unreceived is greater than or equal to a preset threshold. In response to receiving the request information, or based on the number of RLC data packets consecutively unreceived being greater than or equal to the preset threshold, the receiver may determine that the RLC status report needs to be transmitted.

Further, the RLC data packet refers to a data packet transmitted in the RLC layer.

Further, the request information may be transmitted by the transmitter. For example, in the process of transmitting the data with the receiver, the transmitter may periodically (for example, every five transmission time intervals) transmit the request information to the receiver, therefore the transmitter can determine whether the data transmitted in the current five transmission time intervals is successfully received by the receiver based on the RLC status report fed back by the receiver.

Further, the receiver may actively determine whether the number of RLC data packets consecutively unreceived is greater than or equal to a preset threshold, and when the determination result indicates that the number of the RLC data packets consecutively unreceived is greater than or equal to a preset threshold, the receiver may actively transmit the RLC status report to the transmitter, which may timely notify to the transmitter of an abnormality in the data transmission.

Preferably, the preset threshold may be set by the receiver or the transmitter, or may also be pre-defined by the receiver and the transmitter. Those skilled in the art can understand that based on the technical solution of this embodiment, when the receiver finds that the number of the RLC data packets consecutively unreceived is comparably few (for example, one, two, or the like number which is less than the preset threshold), the receiver may speculate that the consecutively unreceived RLC data packet is being transmitted, and the receiver temporarily does not transmit the RLC status report but waits for a period of time, and the transmitter may later transmit over the RLC data packets consecutively unreceived. However, if the number of the RLC data packets consecutively unreceived is comparably large and greater than or equal to the preset threshold, even if the transmitter does not transmit the request information (that is, the RLC state report is not triggered), the receiver may still actively transmit the RLC status report, which can feedback the problem of abnormally receiving current data packets to the transmitter in time.

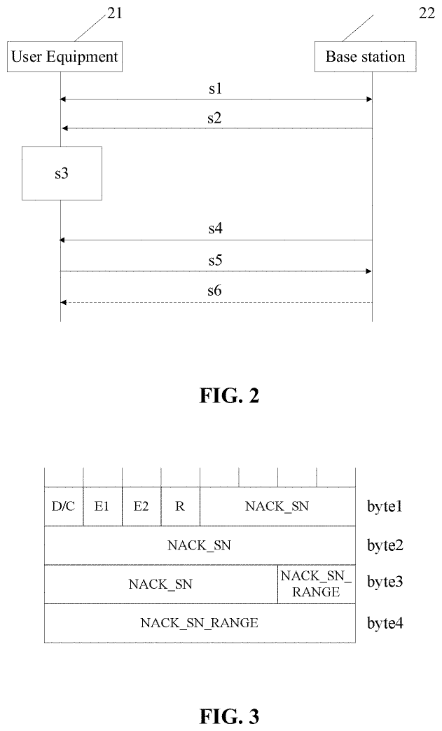

In a preferred example of this embodiment, the set of unacknowledged sequence number length may be received from a transmitter. For example, when establishing a data radio bearer (Data Radio Bearer, DRB for short) with a receiver, the transmitter may determine the element in the set of unacknowledged sequence number length, according to the number of data radio bearers, a transmission rate of each data radio bearer, a channel condition, a service quality requirement (Quality of Service, QoS for short), a size of the RLC data packet, a maximum transmission number of the RLC data packet in a transmission time interval and the like, and transmit the determined set of unacknowledged sequence number length to the receiver along with the configured data radio bearer simultaneously. A typical application scenario adopting this preferred example is specifically described below with reference to FIG. 2.

In a typical application scenario, referring to FIG. 2, a user equipment 21 (User Equipment, UE for short) accesses a cell managed by a base station 22, and performs an action s1 to establish an Radio resource control (Radio Resource Control, RRC for short) connection, after establishing the RRC connection with the base station 22, the base station 22 performs an action s2 to establish a data radio bearer (DRB for short) and starts transmitting data. This application scenario takes the downlink transmission as an example, that is, the base station 22 transmits data to the user equipment 21, where the base station 22 serves as the transmitter and the user equipment 21 serves as the receiver.

Specifically, in practical applications, the user equipment 21 may establish different data radio bearers for different service requirements, and the services may include an instant messaging service, a web browsing service, a downloading service, and the like. Among them, different services correspond to different service quality requirements, therefore different transmission rates are configured.

In this application scenario, the set of unacknowledged sequence number length may include only one element. Specifically, for different data radio bearers configured for the user equipment 21, the base station 22 may obtain the service quality requirements of the current service according to each of the data radio bearers, and further infer factors such as the transmission rate required for data transmission (for example, the number of bits of data needed to be transmitted in a transmission time interval can be deduced to meet the requirement of the transmission rate), and finally determine a unique unacknowledged sequence number length applicable for the data radio bearer according to these factors, wherein the data radio bearer application acknowledgment mode is the RLC layer application acknowledgment mode mapped by the data radio bearer.

For example, for a low-rate service, the base station 22 determines that only one or several RLC data packets are transmitted to the user equipment 21 within a transmission time interval, and therefore the length (also can be called the number) of RLC data packets consecutively unreceived by the user equipment 21 is limited. The base station 21 can infer that, a length such as 6 bits may be large enough to be used to indicate the number of RLC data packets consecutively unreceived in the data radio bearer established based on this service, wherein 6 bits may be used to indicate that the length of RLC data packets consecutively unreceived is up to 64. The base station 21 indicates to the user equipment 21 that the length of the unacknowledged sequence in the RLC status report applicable to the current data radio bearer is 6 by a signaling when performing the action s2, wherein the signaling may be a RRC connection reconfiguration signaling (hereinafter referred to as RRC signaling).

For another example, for a medium-rate service, the base station 22 determines that about 100 data packets may be transmitted to the user equipment 21 in one transmission time interval according to the service quality requirement required by the medium-rate service, and if the base station 22 determines that a maximum of 10 consecutively transmission time intervals may go wrongly, the maximum number of data packets that the user equipment 21 consecutively unreceived is 1000. Therefore, when performing the action s2, the base station 22 may indicate to the user equipment 21 by using the RRC signaling that the length of the unacknowledged sequence in the RLC status report applicable to the current data radio bearer is 10 (as 10th power of 2 is 1024, the maximum number 1000 of consecutively unreceived data packets presumed in this example may be covered).

For another example, for a high-rate service, the base station 22 determines that about 2000 data packets may be transmitted to the user equipment 21 in one transmission time interval according to the service quality requirement required by the high-rate service, and the base station 22 determines that a maximum of 10 consecutively transmission time intervals may go wrongly (for example, the base station 22 may transmit the request message to the user equipment 21 in a period of 10 transmission time intervals to trigger the RLC status report; alternatively, the preset threshold may also be preset by the user equipment 21, and if the preset threshold is 20000, that is to say, when the user equipment 21 consecutively fails to receive 20000 sections of the RLC data packets, it can actively transmit the RLC status report to the base station 22), and the number of consecutively unreceived data packets of the user equipment 21 is not greater than 20,000. Therefore, when performing the action s2, the base station 22 may indicate to the user equipment 21 by using the RRC signaling that the unacknowledged sequence number length in the RLC status report applicable to the current data radio bearer is 15 (as 15th power of 2 is 32768, the maximum number 20000 of consecutively unreceived data packets presumed in this example may be covered).

For a same type of service, a required transmission rate may change during a period of the data transmission performed based on an established data radio bearer. Therefore, when performing the action s2, the base station 22 may properly configure the unacknowledged sequence number length applicable to the RLC status report according to the transmission rate currently required by the service (For example, the unacknowledged sequence number length currently configured is 15, that is, only one element 15 is in the set of unacknowledged sequence number length). And the base station 22 transmits the set of configured unacknowledged sequence number length to the user equipment 21 along with the configured data radio bearer. Afterwards, during the data transmission between the user equipment 21 and the base station 22, the required transmission rate of the service is reduced, and then the base station 22 may modify the element in the set of unacknowledged sequence number length to be 10 with a new signaling. Preferably, the new signaling may be separately transmitted by the base station 22 to the user equipment 21, which may refer to not being transmitted together with the configuration information of the data radio bearer. Those skilled in the art can understand that with the technical solution of this embodiment, the user equipment can better save the number of bits when generating the RLC status report.

Still referring to FIG. 2, in this application scenario, based on the above technical solution, the user equipment 21 performs the action s1 to access the network where the base station 22 is located and establishes an RRC connection with the base station 22. When the user equipment 21 needs to establish a data radio bearer because of a service requirement, the base station 22 performs an action s2 to configure a parameter related to a data radio bearer (which may also be referred to as configuration information of the data radio bearer, and the configuration parameter may include an identification of the data radio bearer and a configuration parameter of layer 2, etc.) for the user equipment 21, and when performing the action s2, the base station 22 further determines an applicable set of unacknowledged sequence number length in the RLC status report for the data radio bearer, according to service quality requirement of the data radio bearer, and transmits the set of unacknowledged sequence number length together with the relevant parameters of the data radio bearer to the user equipment 21 by using the RRC signaling. Preferably, in this application scenario, the set of unacknowledged sequence number length includes only one element.

Further, in this application scenario, after receiving the RRC signaling transmitted by the base station 22, the user equipment 21 performs action s3 to apply the relevant parameters of the data radio bearer included in the RRC signaling to establish the data radio bearer, and saves the set of unacknowledged sequence number length in case to use when it is necessary to report the RLC status.

Further, when the user equipment 21 needs to generate an RLC status report, for example, the base station 22 performs action s4, and transmits an indication (which may also be referred to as a request information) to the user equipment 21 at the RLC layer to trigger the user equipment 21 to transmit the RLC status report of the data radio bearer.

Further, after receiving the indication from the base station 22, the user equipment 21 generates the RLC status report, according to the element in the set of unacknowledged sequence number length applicable to the RLC status report corresponding to the data radio bearer configured by the base station 22, and performs action s5 to transmit the RLC layer status report to the base station 22. Preferably, the user equipment 21 may indicate some information in the RLC status report. The information indicated may include a start RLC sequence number of the RLC data packets consecutively unreceived and the number of the actually RLC data packets consecutively unreceived which is set according to element in the set of unacknowledged sequence number length.

For example, the element in the set of unacknowledged sequence number length configured by the base station 22 is 6, and when an indication is received from the base station 22, a first section of the RLC data packets consecutively unreceived of the user equipment 21 includes SN20 to SN40, and a second section of the RLC data packets consecutively unreceived includes SN80 to SN120, accordingly the user equipment 21 sets the start RLC sequence number (SN) of the RLC data packets consecutively unreceived in the RLC status report to be 20, and further indicates in the RLC status report that the number of consecutively unreceived data packets is 21 (since the unacknowledged sequence number length is 6, if 000000 indicates 0, then 21 may be represented as 010101 using 6-bit binary; or, if 000000 indicates 1, then 21 of 6-bit binary may be represented as 010100). Therefore, the first section of RLC data packets consecutively unreceived can be indicated in the RLC status report (SN20 to SN40). In addition, in the same RLC status report, a start sequence number the RLC data packets consecutively unreceived is also required to be set to be 80, and a number of the RLC data packets consecutively unreceived is also required to be set to be 41 (similarly, 41 needs to be expressed in 6-bit binary), to indicate the second section of the RLC data packets consecutively unreceived (SN80 to SN120) in the same RLC status report.

Further, after executing the action s5, the user equipment 21 transmits the generated RLC status report to the base station 22. Since the base station 22 knows the set of unacknowledged sequence number length by the user equipment (at the same time, the base station 22 may also determine a start position of the unacknowledged sequence number length 6 bits according to the indication of the user equipment 21 in the RLC status report), the base station 22 may explicitly analyze to obtain the number and the sequence number of the RLC data packet consecutively unreceived of the user equipment 21 in the RLC status report.

Further, the base station 22 may perform an action s6 to retransmit the unacknowledged or unreceived RLC data packets indicated in the RLC status report to the user equipment 21, therefore the user equipment 21 can completely receive the data packet.

In a variant, the action s4 may be omitted. For example, the user equipment 21 may actively perform the action s5 after finding that the number of the data packets consecutively unreceived exceeds the preset threshold, so as to transmit the RLC status report to the base station 22. Alternatively, the user equipment 21 may also actively execute the action s5 based on other trigger conditions, and details are not described herein again.

The element in the set of unacknowledged sequence number length is related to factors, such as a scheduling decision of the base station or a size of each data packet. Therefore, different base stations may determine and apply different elements for data radio bearers with the same transmission rate.

In another typical application scenario of this embodiment, the set of unacknowledged sequence number length received from the transmitter may include multiple elements. Still take the downlink transmission as an example, after establishing an RRC connection with the user equipment, the base station may consider about all the required services (and/or all possible data radio bearers) and combine some factors such as the required transmission rate of the data radio bearer and the service quality requirements, to comprehensively determine the unacknowledged sequence number applicable to multiple RLC status reports, and transmit the set of unacknowledged sequence number length which consists of the multiple unacknowledged sequence number length (i.e., multiple elements) to the user equipment.

In a preferred example, when the RLC status report needs to be transmitted, the user equipment may select a fixed one of a plurality of elements included in the set of unacknowledged sequence number length to generate the RLC status report. For example, when the RLC status report needs to be transmitted, a plurality of sections of the RLC data packets consecutively unreceived may be required to be indicated in the RLC status report (during a period from a time point when the RLC status report is transmitted last time to a time point when an RLC status report needs to be transmitted this time, more transmission time intervals may pass, and in the more transmission time intervals, multiple consecutive data packets may be unreceived intermittently by the user equipment). The user equipment may select the applicable element from the set of unacknowledged sequence number length according to the maximum number of the data packets consecutively unreceived.

Take a condition that the set of unacknowledged sequence number length includes three elements of 6, 10 and 15 as an example. When the RLC status report needs to be transmitted, two sections of RLC data packets that have not been received consecutively need to be indicated in the RLC status report, the sequence numbers of the first section of the consecutively unreceived data packets are SN20 to SN60 (the corresponding number of the consecutively unreceived data packets is 41), and the sequence numbers of the second section of the consecutively unreceived data packets are SN90 to SN200 (the corresponding number of the consecutively unreceived data packets is 111). The user equipment may select the element 10 from the set of unacknowledged sequence number length to be the at least one unacknowledged sequence number length according to the number of the data packets consecutively unreceived of the second section (that is, 111), and indicate the two sections of the RLC data packets consecutively unreceived in the RLC status report based on the element 10.

In a variant, when the RLC status report needs to be transmitted, the user equipment may select multiple elements from the plurality of elements included in the set of unacknowledged sequence number length as the at least one unacknowledged sequence number length, to generate the RLC status report. Preferably, for each section of the RLC data packet consecutively unreceived, an applicable unacknowledged sequence number length may be selected from the set of unacknowledged sequence number length according to the number of RLC data packets consecutively unreceived. For example, an applicable minimum unacknowledged sequence number length may be determined according to the number of RLC data packets consecutively unreceived in each section. Each section of the RLC data packets consecutively unreceived may be the RLC data packets consecutively unreceived in one transmission time interval, or may be each section of the data packets consecutively unreceived in multiple transmission time intervals.

Still take the condition that the set of unacknowledged sequence number length includes three elements of 6, 10 and 15 as an example. When the RLC status report needs to be transmitted, two sections of RLC data packets that are unreceived consecutively need to be indicated in the RLC status report, wherein the sequence numbers of data packets consecutively unreceived in the first section are SN20 to SN60 (the corresponding number of data packets consecutively unreceived is 41), and the sequence numbers of data packets consecutively unreceived in the second section are SN1000 to SN2000 (the corresponding number of data packets consecutively unreceived is 1001). For the first section of RLC data packets consecutively unreceived, based on the second section of RLC data packets consecutively unreceived (i.e., 41), the user equipment may select the element 6 from the set of unacknowledged sequence number length as the unacknowledged sequence number length applicable to the first section of RLC data packets consecutively unreceived. For the second section of RLC data packets consecutively unreceived, based on the number of the second section of RLC data packets consecutively unreceived (i.e., 1001), the user equipment may select the element 10 from the set of unacknowledged sequence number length as the unacknowledged sequence number length applicable to the second section of RLC data packets consecutively unreceived, and respectively indicates the first section and the second section of RLC data packets consecutively unreceived in the RLC status report based on the element 6 and the element 10.

In another preferable embodiment of this embodiment, the elements in the set of unacknowledged sequence number length may be pre-defined by the transmitter and the receiver, wherein the set of unacknowledged sequence number length includes one or more elements.

Still taking the downlink transmission as an example. The user equipment starts to receive the data transmitted by the base station after accessing the network in which the base station is located. For the user equipment and the base station that are in the acknowledgment mode, when the determination result of the step S101 indicates that the RLC status report needs to be transmitted, an RLC entity of the user equipment (the RLC entity is used to specifically be responsible for processing the RLC Layer from a software prospect, the processing may include all operations of the RLC layer) may transmit the RLC status report to the base station.

Specifically, the user equipment needs to determine an applicable unacknowledged sequence number length in the RLC status report. More specifically, the user equipment may determine at least one applicable unacknowledged sequence number length from the set of unacknowledged sequence number length according to the number of RLC data packets consecutively unreceived. Still further, the user equipment needs to indicate the at least one applicable unacknowledged sequence number length in the RLC status report.

Further, before completing the RRC connection (or before establishing the data radio bearer, and after establishing the RRC connection), the user equipment may pre-define with the base station to determine elements that can be included in the set of unacknowledged sequence number length. For example, the user equipment feeds back to the base station a data radio bearer that the user equipment may need to establish within a preset time period. The base station combines factors, such as the data radio bearer, service quality requirement, transmission rate, the number of data packets transmitted in an interval or the possible size of the data packet, to configure one or more unacknowledged sequence number length that may be applicable to the user equipment to combine the unacknowledged sequence number length set, and transmit the set to the user equipment. The set of unacknowledged sequence number length is respectively saved by the base station and the user equipment for later use. Preferably, the unacknowledged sequence number length may correspond to the data radio bearer in a one-to-one manner, that is, the user equipment may establish multiple data radio bearers, and each data radio bearer may correspond to an unacknowledged sequence number length. All unacknowledged sequence number length may form the set of unacknowledged sequence number length. The user equipment may pre-define with the base station to determine elements that may be included in the set of unacknowledged sequence number length set. Further, the elements that may be included in the set of unacknowledged sequence number length may further include elements that may be included in the unacknowledged sequence of sequence number length preset by a protocol.

In a typical application scenario, the pre-defined set of unacknowledged sequence number length may include only one element, and when the RLC status report needs to be transmitted, the user equipment may generate the RLC status report according to the element and transmit the RLC status report to the base station.

In another typical application scenario, the pre-defined set of unacknowledged sequence number length may further include multiple elements, and when the RLC status report needs to be transmitted, the user equipment may select a fixed one from the multiple elements as the at least one unacknowledged sequence number length, generate the RLC status report based on the fixed one element, and transmit the RLC status report to the base station. Preferably, the method for selecting one fixed element from the plurality of elements in the application scenario as the at least one unacknowledged sequence number length may be similar with the above method for selecting a fixed one of the plurality of elements from the set of unacknowledged sequence number length received from the transmitter as the length of the at least one unacknowledged sequence number.

In practical applications, the user equipment may establish multiple data radio bearers and determine a length of an unacknowledged sequence number applicable in the RLC status report according to each data radio bearer, wherein the unacknowledged sequence number length respectively corresponding to the multiple data radio bearers constitutes the set of unacknowledged sequence number length. Further, when the user equipment needs to transmit the RLC status report, the user equipment can generate the RLC status report by selecting an element suitable for the number of the data packets consecutively unreceived from the set of unacknowledged sequence number length.

Take a condition that the unacknowledged sequence number length set includes four elements (element 6, element 10, element 15 and element 18 respectively) as an example. When an RLC status report needs to be reported, the user equipment may determine the applicable unacknowledged sequence number length in the RLC status report, according to a maximum number of the RLC data packets consecutively unreceived. For example, when the RLC status report needs to be transmitted, the user equipment finds that the consecutively unreceived data packets include SN20 to SN45 (corresponding number of the consecutively unacknowledged data packets is 26), SN60 to SN90 (corresponding number of the consecutively unacknowledged data packets is 31), and SN100 to SN140 (corresponding number of the consecutively unreceived data packets is 41). The maximum number of the consecutively unreceived data packets is 41, therefore the user equipment may select an element 6 (i.e., a 6-bit length) from the set of unacknowledged sequence number length as the at least one unacknowledged sequence number length. The user equipment may seriatim indicate the number of the RLC data packets consecutively unreceived in each section based on the element 6 in the RLC status report.

As a variation of this application scenario, the user equipment may further select multiple elements from the multiple elements included in the predefined set of unacknowledged sequence number length as the at least one unacknowledged sequence identifier length. Specifically, similar to the above method for selecting a plurality of elements from the plurality of elements included in the set of unacknowledged sequence number length received from the transmitter as the at least one unacknowledged sequence number length, in this variation, for each section of the RLC data packets consecutively unreceived, the user equipment may select an appropriate unacknowledged sequence number length from the set of unacknowledged sequence number length according to the number of RLC data packets consecutively unreceived.

Preferably, for each section of the RLC data packet consecutively unreceived, the user equipment may select a minimum optional unacknowledged sequence number length capable of representing the number of RLC data packets consecutively unreceived to generate the RLC state report. For example, when it is needed to transmit the RLC status report, the user equipment discovers that RLC data packets consecutively unreceived sequentially are SN20 to SN60 and SN1000 to SN2000. The user equipment may sequentially select an element that unacknowledged sequence number length is 6 bits and 10 bits as the at least one set of unacknowledged sequence number length. Further, the user equipment further needs to separately indicate the at least one unacknowledged sequence number length determined by the user equipment, and the number of the consecutively unreceived RLC data packets indicated based on the at least one unacknowledged sequence number length is 41 (indicated with 6-bit) and 1001 (indicated with 10-bit) in the RLC status report. Then, the user equipment transmits the generated RLC status report to the base station.

Finally, after analyzing the RLC status report, for the unacknowledged or unreceived RLC data packet indicated in the RLC status report, the base station may choose to re-transmit the RLC data packet to the user equipment.

Further, the user equipment may generate the RLC status report with reference to the RLC status report format shown in FIG. 3. The division of the information elements included in the RLC status report format (for example, byte 1 to byte 4) may refer to the existing techniques. Unlike the existing technology, the user equipment may indicate the length of the unacknowledged sequence number in a format of RLC status report.

In a preferable example, as shown in FIG. 3, the information element D/C included in the RLC status report may be used to indicate that the content transmitted this time is an RLC status report or an RLC data packet. The information element E1 may be used to indicate the element selected by the at least one unacknowledged sequence number length; or, the information element E1 together with the information element E2 may be used to indicate the element selected by the at least one unacknowledged sequence number length; and the fourth information element R is a reserved bit. The information element NACK_SN may be used to indicate the start RLC sequence number of the RLC data packets consecutively unreceived; and the information element NACK_SN_RANGE may be used to indicate the at least one unacknowledged sequence number length.

For example, when the set of unacknowledged sequence number length received from the transmitter includes only one element, or when the set of unacknowledged sequence number length received from the transmitter includes a plurality of elements, while the user equipment only selects one fixed element from the set of unacknowledged sequence number length, the user equipment may indicate the element in the specific information element of the RLC status report format shown in FIG. 3 according to an instruction of the transmitter, and sequentially indicate the start RLC sequence number of each section of the RLC data packets consecutively unreceived and the number of the RLC data packets consecutively unreceived in the specific information element of the RLC status report.

Preferably, since the format of the RLC status report which the user equipment complies with when generating the RLC status report is predetermined by the base station in the form of the instruction or is preset by a protocol, and after receiving the RLC status report from the user equipment, the base station knows which information elements to go in order to intercept the required data.

Or, when the predetermined set of unacknowledged sequence number length (no matter whether received from the transmitter) includes only one element, or when the predetermined set of unacknowledged sequence number length includes a plurality of elements, while the user equipment only selects one fixed element from the set of unacknowledged sequence number length, the user equipment may indicate the element in the specific information element of the RLC status report format shown in FIG. 3 according to the predetermined rule, and sequentially indicate the sequence number of the starting RLC data packet of each section of the RLC data packets consecutively unreceived and the number of the RLC data packets consecutively unreceived in the specific information element of the RLC status report. Preferably, the base station knows which information elements to go in order to intercept the required data according to the predetermined rule.

Specifically, take a case that the set of unacknowledged sequence number length includes 4 elements as an example. The user equipment may pre-agree with the base station, an element whose unacknowledged sequence number length is 6 bits is indicated by 00 in the RLC status report; an element whose unacknowledged sequence number length is 10 bits is indicated by 01 in the RLC status report; an element whose unacknowledged sequence number length is 15 bits is indicated by 10 in the RLC status report; and an element whose unacknowledged sequence number length is 18 bits is indicated by 11 in the RLC status report.

Based on the RLC status report format shown in FIG. 3, when it is needed to transmit the RLC status report, if the user equipment finds that the data packets consecutively unreceived include SN20 to SN45 (corresponding number of the data packets consecutively unreceived is 26), SN60 to SN90 (corresponding number of the data packets consecutively unreceived is 31), and SN100 to SN140 (corresponding number of the data packets consecutively unreceived is 41). The maximum number of the RLC data packets consecutively unreceived is 41, therefore the user equipment may select an element 6 (i.e., a 6-bit length) from the set of unacknowledged sequence number length as the at least one unacknowledged sequence number length. The user equipment may indicate 00 on a specific bit (or location) in the RLC status report, for example the user equipment may configure the unacknowledged sequence number length at a preset location (such as information element E1 and/or information element E2) of the RLC status report.

Further, a specific bit (or location) at the start position of the RLC status report (such as information element D/C) specifically indicates that the content transmitted this time is a status report, so that the base station confirms the content received this time to be data or a status report. In this way, the base station can learn the at least one unacknowledged sequence number length used by the user equipment, after receiving the RLC status report.

Besides, based on the RLC status report format shown in FIG. 3, to the first section of the data packets consecutively unreceived SN20 to SN45, the user equipment may set the sequence number of the initial RLC data packet of the RLC data packets consecutively unreceived in the information element NACK_SN to be 20, and then set the unacknowledged sequence number length corresponding to the sequence number 20 to be 26 (represented by a length of 6 bits) in the information element NACK_SN_RANGE. And to the second section of the data packets consecutively unreceived SN60 to SN90, the user equipment may also set the sequence number of the initial RLC data packet of the RLC data packets consecutively unreceived in the information element NACK_SN to be 60, and then set the unacknowledged sequence number length corresponding to the sequence number 60 to be 31 (represented by a length of 6 bits) in the information element NACK_SN_RANGE. And to the third section of the consecutively unreceived data packets SN100 to SN140, the user equipment may also set the sequence number of the initial RLC data packet of the RLC data packets consecutively unreceived in the information element NACK_SN to be 100, and then set the unacknowledged sequence number length corresponding to the sequence number 100 to be 41 (represented by a length of 6 bits) in the information element NACK_SN_RANGE.

Further, after receiving the RLC status report, the base station may determine that the selected element of the at least one unacknowledged sequence number length used by the current RLC status report is 6 bits from the information element E1. Based on the information of the information element NACK_SN, the base station may determine a start sequence number of the RLC data packets consecutively unreceived indicated by the at least one unacknowledged sequence number length (ie, 6 bits), and determine the unacknowledged sequence number length corresponding to the sequence number based on the information element NACK_SN_RANGE, so as to determine all RLC data packets consecutively unreceived of the user equipment.

For another example, when receiving an unacknowledged sequence number length set (or the pre-defined unacknowledged sequence number length set) from the transmitter includes a plurality of elements, and the user equipment selects multiple elements from the plurality of elements as the at least one unacknowledged sequence number length, the user equipment may indicate each selected element in the RLC status report.

Specifically, the user equipment may sequentially indicate each selected element in sequence in a preset position (such as information element E1) of the RLC status report, and may sequentially indicate the initial RLC sequence number of the RLC data packets consecutively unreceived and the length of each consecutively unreceived RLC data packets in sequence through the information element NACK_SN and the information element NACK_SN_RANGE. For example, when it is needed to transmit the RLC status report, the user equipment finds that the RLC data packets consecutively unreceived are SN20 to SN60 and SN1000 to SN2000 in sequence, and then the user equipment may sequentially indicate that the selected elements are respectively 6 bits and 10 bits in the information element E1, and based on the sequence, the user equipment first indicates the initial RLC sequence numbers of the RLC data packets consecutively unreceived to be SN20 in the information element NACK_SN and then the length (i.e. the number) of the RLC data packets consecutively unreceived to be 41 (using a 6-bit to indicate); and then indicates the initial RLC sequence number of RLC data packet consecutively unreceived to be SN1000, and the length (i.e. number) of the RLC data packets consecutively unreceived is 1001 (using a 10-bit to indicate).

Alternatively, in the RLC status report, for each unacknowledged sequence number length, the user equipment may further indicate the selected element of the unacknowledged sequence number length in a information element (for example, one bit or a few bits may be used) preceding the start position of the unacknowledged sequence number length.

Specifically, the difference from the above examples lies in that: rather than sequentially indicating each selected element in sequence in a preset position (such as information element E1) of the RLC status report, the user equipment first indicates the element of the unacknowledged sequence number length to be adopted before the information element (IE) group including the IE NACK_SN and the IE NACK_SN_RANGE (for example, the IE NACK_SN and the IE NACK_SN_RANGE may constitute one group), and then indicate the initial RLC sequence numbers of the consecutively unrecovered RLC data packets indicated by the unacknowledged sequence number and the unacknowledged sequence number length.

Take a case that the RLC data packets consecutively unreceived are sequentially SN20 to SN60 and SN1000 to SN2000 as an example. The user equipment may indicate the selected element of the unacknowledged sequence number length to be 6 before the information element group including the IE NACK_SN and the IE NACK_SN_RANGE, and then indicate that the sequence number of the initial RLC data packet of the RLC data packets consecutively unreceived to be SN20 in the next position and the length of the RLC data packets consecutively unreceived is 41 (using a 6-bit to indicate); and then indicate the selected element by the unacknowledged sequence number length to be used next to be 10, following indicating the initial RLC sequence number of the RLC data packets consecutively unreceived at the next location to be SN1000, and the length of the RLC data packets consecutively unreceived to be 1001 (indicated with 10 bits).

From above, in the first embodiment, by determining the unacknowledged sequence number length (for example, different service types or different data radio bearers may correspond to different unacknowledged sequence number lengths) that can be used in the RLC status report, the receiver may determine the length of the unacknowledged sequence included in the RLC status report to be transmitted this time accordingly, so as to transmit the RLC status report with a fewer number of bits to improve the transmission efficiency.

Further, embodiments of the present disclosure allow the RLC status report generated and transmitted includes at least one unacknowledged sequence number length, therefore the length of the unacknowledged sequence numbers included in the RLC status report can be flexibly changed according to actual reception conditions of the receiver, therefore the RLC status report transmitted by the receiver may occupy fewer bits and improve the transmission efficiency.

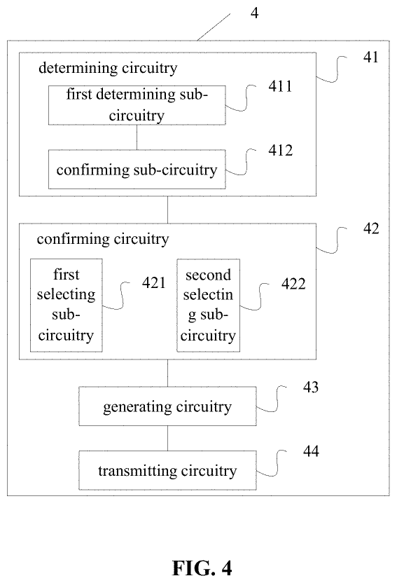

FIG. 4 schematically illustrates a structural diagram of an apparatus for reporting an RLC layer status according to a second embodiment of the present disclosure. Those skilled in the art can understand that, the apparatus 4 for reporting an RLC layer status in this embodiment is used to implement the method technical solutions described in the embodiments shown in FIG. 1 to FIG. 3. Specifically, in this embodiment, the apparatus 4 for transmitting an RLC layer status report may include: a determining circuitry 41 which may be configured to determine whether an RLC status report needs to be transmitted, based on being in an acknowledgment mode; a confirming circuitry 42 which may be configured to: based on that the RLC status report needs to be transmitted, determine at least one unacknowledged sequence number length, wherein the unacknowledged sequence number length is selected from a set of unacknowledged sequence number length; a generating circuitry 43 which may be configured to: generate the RLC status report based on the at least one unacknowledged sequence number length, wherein the RLC status report is in a preset format of RLC status report; and a transmitting circuitry 44 which may be configured to: transmit the RLC status report.

Further, the determining circuitry 41 includes may include a first determining sub-circuitry 411, configured to: determine whether a request information for acquiring the RLC status report is received or not, or determining whether a number of RLC data packet consecutively unreceived is greater than or equal to a preset threshold; and a confirming sub-circuitry 412, configured to: in response to the request information being received, or based on the number of RLC data packets consecutively unreceived being greater than or equal to the preset threshold, determining that the RLC status report needs to be transmitted.

Preferably, the set of unacknowledged sequence number length is received from a transmitter, and includes one or a plurality of elements.

Further, based on the set of unacknowledged sequence number length including a plurality of elements, a fixed one of the plurality of elements is selected as the at least one unacknowledged sequence number length, or multiple elements of the plurality of elements are selected as the at least one unacknowledged sequence number length.

Further, based on multiple elements of the set of unacknowledged sequence number length being selected as the at least one unacknowledged sequence number length, the confirming circuitry 42 includes: a first selecting sub-circuitry 421, configured to: for each section of RLC data packets consecutively unreceived, select a suitable unacknowledged sequence number length from the set of unacknowledged sequence number length according to the number of the RLC data packets consecutively unreceived.

Preferably, the element in the set of unacknowledged sequence number length is determined by the transmitter according to one or more of parameter below: a number of a data radio bearer; transmission rate; service quality requirement, size of the RLC data packet and a maximum transmission number of the RLC data packets in a transmission time interval.

In another preferable embodiment, the element in the set of unacknowledged sequence number length is pre-defined by a transmitter and the receiver, and the unacknowledged sequence includes one or a plurality of elements.

Further, based on the set of unacknowledged sequence number length including a plurality of elements, a fixed one of the plurality of elements is selected as the at least one unacknowledged sequence number length, or multiple elements of the plurality of elements are selected as the at least one unacknowledged sequence number length.

Further, based on multiple elements of the set of unacknowledged sequence number length being selected as the at least one unacknowledged sequence number length, the confirming circuitry 42 includes: a second selecting sub-circuitry 422, configured to: for each section of RLC data packets consecutively unreceived, selecting a suitable unacknowledged sequence number length from the set of unacknowledged sequence number length according to the number of the RLC data packets consecutively unreceived.

Further, based on multiple elements of the set of unacknowledged sequence number length being selected as the at least one unacknowledged sequence number length, the generating circuitry 43 is configured to: further indicate each of the selected elements in the RLC status report. Preferably, the generating circuitry 43 may be configured to: sequentially indicate each selected element in sequence in a preset position of the RLC status report. Alternatively, in the RLC status report, for each unacknowledged sequence length, the generating circuitry 43 may indicate that the elements selected by the unacknowledged sequence number length before a preceding information element of the start position of the unacknowledged sequence length.

Further, the RLC status report further includes a start RLC sequence number of the RLC data packets consecutively unreceived.

In a variant, the apparatus for transmitting an RLC layer status report 4 may further include a receiving circuitry (not shown in the FIG. 4), where the receiving circuitry is configured to receive the RLC data packet retransmitted by the transmitter.

Further, an embodiment of the present disclosure further discloses a storage medium on which computer instructions are stored. When the computer instruction runs, the method and the technical solution described in the embodiments shown in FIG. 1 to FIG. 3 are performed. Preferably, the storage medium may include a computer-readable storage medium. The storage medium may include a ROM, a RAM, a magnetic disk, an optical disk, or the like.

Further, an embodiment of the present disclosure further discloses a user equipment, including a memory and a processor, where the memory stores computer instructions capable of running on the processor, where the processor executes the computer instructions to execute the technical solution of the method described in the embodiments shown in FIG. 1 to FIG. 3 is as follows.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for reporting a Radio Link Control (RLC) layer status, comprising:
determining whether an RLC status report needs to be transmitted, based on being in an acknowledgment mode;
based on that the RLC status report needs to be transmitted, determining at least one unacknowledged sequence number length, wherein the unacknowledged sequence number length is selected from a set of unacknowledged sequence number length which comprises one or more elements, and the one or more elements in the set of unacknowledged sequence number length are pre-defined by a transmitter and a receiver;
generating the RLC status report based on the at least one unacknowledged sequence number length and a sequence number of a start RLC data packet of RLC data packets consecutively unreceived, wherein the RLC status report is in a preset format of RLC status report, and the RLC status report records the total number of the RLC data packets consecutively unreceived and the sequence number of the start RLC data packet of RLC data packets consecutively unreceived; and
transmitting the RLC status report.

2. The method according to claim 1, wherein determining whether an RLC status report needs to be transmitted, comprises:
determining whether a request information for acquiring the RLC status report is received, or determining whether a number of RLC data packets consecutively unreceived is greater than or equal to a preset threshold; and
in response to the request information being received, or based on the number of RLC data packets consecutively unreceived being greater than or equal to the preset threshold, determining that the RLC status report needs to be transmitted.

3. The method according to claim 1, wherein based on the set of unacknowledged sequence number length comprising a plurality of elements, a fixed one of the plurality of elements is selected as the at least one unacknowledged sequence number length, or multiple elements of the plurality of elements are selected as the at least one unacknowledged sequence number length.

4. The method according to claim 3, wherein based on multiple elements being selected from the set of unacknowledged sequence number length as the at least one unacknowledged sequence number length, determining the at least one unacknowledged sequence number length comprises:
for each section of RLC data packets consecutively unreceived, selecting a suitable unacknowledged sequence number length from the set of unacknowledged sequence number length based on the number of the RLC data packets consecutively unreceived.

5. The method according to claim 3, wherein based on multiple elements being selected from the set of unacknowledged sequence number length as the at least one unacknowledged sequence number length, the RLC status report further indicates each of the selected elements.

6. The method according to claim 1, wherein the RLC status report further indicates multiple sections, and each one of the multiple sections is indicated with a start sequence number and the corresponding unacknowledged sequence number through at least one unacknowledged sequence number length.

7. The method according to claim 5, wherein in the RLC status report, for each of the unacknowledged sequence number length, an information element before a start position of the unacknowledged sequence number length indicates a selected element of the unacknowledged sequence number length.

8. The method according to claim 5, wherein the RLC status report further comprises a start sequence number of the RLC data packets consecutively unreceived which are indicated by each unacknowledged sequence number length.

9. An apparatus for reporting a Radio Link Control (RLC) layer status, comprising:
a determining circuitry, configured to determine whether an RLC status report needs to be transmitted, based on being in an acknowledgment mode;
a confirming circuitry, configured to: based on that the RLC status report needs to be transmitted, determine at least one unacknowledged sequence number length, wherein the unacknowledged sequence number length is selected from a set of unacknowledged sequence number length which comprises one or more elements, and the one or more elements in the set of unacknowledged sequence number length are pre-defined by a transmitter and a receiver;
a generating circuitry, configured to: generate the RLC status report based on the at least one unacknowledged sequence number length and a sequence number of a start RLC data packet of the RLC data packets consecutively unreceived, wherein the RLC status report is in a preset format of RLC status report, and the RLC status report records the total number of the RLC data packets consecutively unreceived and the sequence number of the start RLC data packet of RLC data packets consecutively unreceived; and
a transmitting circuitry, configured to: transmit the RLC status report.

10. The apparatus according to claim 9, wherein the determining circuitry comprises:
a first determining sub-circuitry, configured to: determine whether a request information for acquiring the RLC status report is received, or determine whether a number of RLC data packets consecutively unreceived is greater than or equal to a preset threshold; and
a confirming sub-circuitry, configured to: in response to the request information being received, or based on the number of RLC data packets consecutively unreceived being greater than or equal to the preset threshold, determine that the RLC status report needs to be transmitted.

11. The apparatus according to claim 9, wherein based on the set of unacknowledged sequence number length comprising a plurality of elements, a fixed one of the plurality of elements is selected as the at least one unacknowledged sequence number length, or multiple elements of the plurality of elements are selected as the at least one unacknowledged sequence number length.

12. The apparatus according to claim 11, wherein based on multiple elements being selected from the set of unacknowledged sequence number length as the at least one unacknowledged sequence number length, the confirming circuitry comprises:
a second selecting sub-circuitry, configured to: for each section of RLC data packets consecutively unreceived, select a suitable unacknowledged sequence number length from the set of unacknowledged sequence number length based on the number of the RLC data packets consecutively unreceived.

13. The apparatus according to claim 11, wherein based on multiple elements being selected from the set of unacknowledged sequence number length as the at least one unacknowledged sequence number length, the generating circuitry is configured to: further indicate each of the selected elements in the RLC status report.

14. The apparatus according to claim 9, wherein the RLC status report further indicates multiple sections, and each one of the multiple sections is indicated with a start sequence number and the corresponding unacknowledged sequence number through at least one unacknowledged sequence number length.

15. The apparatus according to claim 13, wherein in the RLC status report, for each of the unacknowledged sequence number length, an information element before a start position of the unacknowledged sequence number length indicates a selected element of the unacknowledged sequence number length.

16. The apparatus according to claim 13, wherein the RLC status report further comprises a start sequence number of the RLC data packets consecutively unreceived that are indicated by each unacknowledged sequence number length.

17. A non-transitory storage medium storing one or more programs, the one or more programs comprising computer instructions, which, when executed by a processor, cause the processor to:
determine whether a Radio Link Control (RLC) status report needs to be transmitted, based on being in an acknowledgment mode;
based on that the RLC status report needs to be transmitted, determine at least one unacknowledged sequence number length, wherein the unacknowledged sequence number length is selected from a set of unacknowledged sequence number length which comprises one or more elements, and the one or more elements in the set of unacknowledged sequence number length are pre-defined by a transmitter and a receiver;
generate the RLC status report based on the at least one unacknowledged sequence number length and a sequence number of a start RLC data packet of RLC data packets consecutively unreceived, wherein the RLC status report is in a preset format of RLC status report, and the RLC status report records the total number of the RLC data packets consecutively unreceived and the sequence number of the start RLC data packet of RLC data packets consecutively unreceived; and
transmit the RLC status report.

18. A user equipment comprising a memory and a processor, wherein the memory has computer instructions stored therein, and once executing the computer instructions, the processor performs the method according to claim 1.
